(19) United States
(12) Patent Application Publication
(10) Pub. No.: US 2026/0094756 A1
(43) Pub. Date: Apr. 2, 2026

(54) ELECTRONIC COMPONENT AND COIL COMPONENT

(71) Applicant: TDK CORPORATION, Tokyo (JP)

(72) Inventor: Hideaki HARATA, Tokyo (JP)

(73) Assignee: TDK CORPORATION, Tokyo (JP)

(21) Appl. No.: 19/336,863

(22) Filed: Sep. 23, 2025

(30) Foreign Application Priority Data
Sep. 30, 2024 (JP) 2024-171438

(51) Int. Cl. H01F 27/29

(52) U.S. Cl. CPC H01F 27/292

(57) ABSTRACT

An electronic component including: a member at least installed with a terminal or an electrode, wherein a surface of the member has a detection motif having a pattern with a width or a spacing smaller than a size of a foreign object to be detected.

### TECHNICAL FIELD

The present disclosure relates to an electronic component and a coil component.

### BACKGROUND

As described in Patent Document 1 shown below, a surface-mounting coil component has been developed. In this type of coil component, adhesion of a foreign object may become a problem during a production process. Specifically, the foreign object such as pieces (fragments) of a solder ball, a ferrite core, or so may adhere on the surface of the coil component.

In order to prevent the product from being dispatched with the foreign object adhered on the product, adhesion of the foreign object is checked visually or by using a camera. Upon detecting the foreign object, when a predetermined number of foreign objects each having a predetermined size or lager is detected in a predetermined field of view, the product which the foreign object has been detected under said condition is sent to a cleaning step or so.

However, it may be difficult to promptly and objectively detect a foreign object having a predetermined size or larger visually or by using a camera. Such difficulty relating to the detection of the foreign object does not only apply to the coil component, but also applies to a wide range of electronic components having a terminal and an electrode.

### PRIOR ART DOCUMENT

[Patent Document 1] JP Patent Application Laid Open No. 2015-216302

### SUMMARY

The present invention is achieved in view of such circumstances, and the object is to provide an electronic component and a coil component which easily achieves objective and prompt detection of a foreign object having a predetermined size or larger by checking visually or by using a camera.

In order to achieve the above-mentioned object, an electronic component according to one aspect of the present disclosure includes:
a member at least installed with a terminal or an electrode,
wherein a surface of the member has a detection motif having a pattern with a width or a spacing smaller than a size of a foreign object to be detected.

In order to achieve the above-mentioned object, a coil component according to one aspect of the present disclosure includes:
a terminal block for installing a terminal,
wherein a surface of the terminal block has a detection motif having a pattern with a width or a spacing smaller than a size of a foreign object to be detected.

The terminal may include a wire connection part and a mounting part, and a surface of the terminal block positioned near the wire connection part or the mounting part may have the detection pattern.

Also, the coil component may further include a cover including a terminal block covering part at least partially covering the terminal block, and a surface of the cover near the terminal may at least have the detection motif.

According to the electronic component including such coil component, in the case that the foreign object exists on the detection motif, the foreign object is observed while having the detection motif in the background. Hence, the size of the foreign object can be compared to a width of a pattern or a spacing between the patterns, thus it can be easily determined whether the size of the foreign object is larger or not compared to the width or the spacing. Therefore, according to this electronic component (including a coil component), a prompt and objective detection of the foreign object having a predetermined size or larger can be done easily by visually checking from the outside, by checking the outside using a foreign object detection device (camera), and the like.

For example, the pattern width or the pattern spacing of the detection motif may be 0.1 to 5 mm, 0.1 to 3 mm, 0.1 to 1 mm, or 0.1 to 0.5 mm. As the size of the foreign object to be detected, many of the smaller foreign objects are 0.1 mm or larger, and the foreign objects larger than 5 mm are rare, although this depends on the type of the foreign object. Therefore, the pattern width or the pattern spacing of the detection motif may preferably be within the above-mentioned range. However, the pattern width or the pattern spacing may be out of this range depending on the size of the foreign object to be detected.

Note that, depending on the position where the motif is formed, the motif can be used as a mark for setting the position when other components such as a core is installed, and the pattern motif can be used for the improved position precision of the installing members such as a core and the like.

Preferably, the detection motif is a repetitive pattern with ridges and grooves formed on the surface of the component. The pattern motif may not have ridges and grooves; however, preferably by having the pattern motif having a repetitive pattern with ridges and grooves, the foreign object on the pattern motif can be observed even more clearly in three-dimension due the difference in reflected light of illumination light. Thus, a detection precision of the foreign object further improves.

The adhesive applied on a predetermined area may contact the surface of the member having the detection motif. Due to the pattern motif having a repetitive pattern, the adhesive is held in a groove portion; hence, an improved adhesive strength can be anticipated. Further, depending on the direction or so of the motif, it may be effective to prevent leakage and spreading of the adhesive; hence, the adhesive can be easily applied effectively on the predetermined area where it should be adhered. Note that, when the adhesive has leaked and spread to the area larger than expected, then the adhesive may drip and may not have sufficient height; hence, the adhesive effect may be lowered.

### BRIEF DESCRIPTION DRAWINGS

FIG. 1 is a perspective view of a coil component according to one embodiment.

FIG. 2 is an explosive perspective view of the coil component shown in FIG. 1.

FIG. 3 is a perspective view showing a configuration of a bobbin of the coil component shown in FIG. 1.

FIG. 4 is a perspective view showing a configuration of a cover of the coil component shown in FIG. 1.

FIG. 5 is a perspective view showing a configuration of a core and a fixing tape of the coil component shown in FIG. 1.

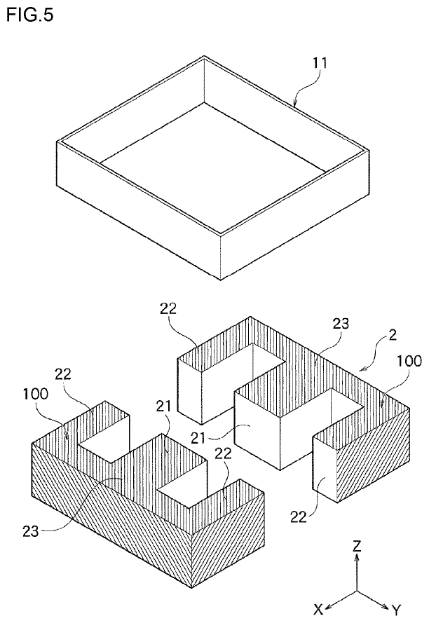

FIG. 6 is a front view of the coil component shown in FIG. 1 at the state prior to installing the core.

FIG. 7 is a front view of the coil component shown in FIG. 1.

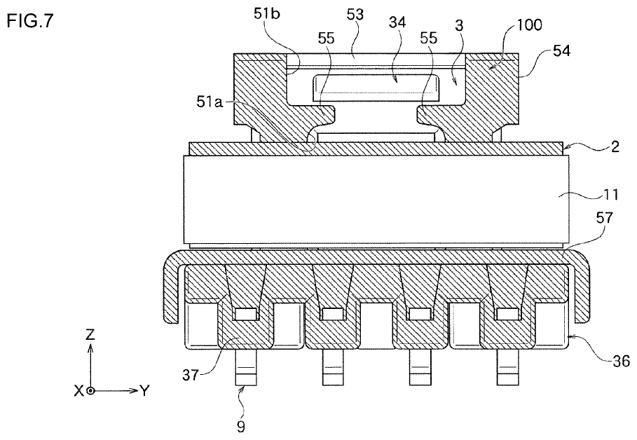

FIG. 8 is a bottom view showing a configuration of a coil portion of the coil component shown in FIG. 1.

FIG. 9 is a plan view showing a configuration of a coil portion of the coil component shown in FIG. 1.

FIG. 10A is an enlarged perspective view of a main part of a detection motif formed on a surface of a bobbin shown in FIG. 1.

FIG. 10B is an enlarged perspective view of a main part of a modified example of a detection motif formed on a surface of a bobbin shown in FIG. 1.

FIG. 10C is an enlarged perspective view of a main part of a modified example of a detection motif formed on a surface of a bobbin shown in FIG. 1.

FIG. 10D is an enlarged perspective view of a main part of a modified example of a detection motif formed on a surface of a bobbin shown in FIG. 1.

FIG. 11A is a photograph of an example showing the state when a foreign object is detected on the detection motif shown in FIG. 10A.

FIG. 11B is a photograph according to a comparative example showing the state when the foreign object exists on the surface of the bobbin without having the detection motif as shown in FIG. 10A.

FIG. 12 is a perspective view of a coil component according to another embodiment.

FIG. 13 is a perspective view of a chip component as one example of the electronic component according to one embodiment.

### DETAILED DESCRIPTION

Below describes embodiments of the present disclosure. The embodiments of the present disclosure are explained by referring to the figures if needed; however, the contents of the figures are schematic and exemplary representations, and these may not be precise representation of the actual appearance and size. Hereinafter, the present disclosure is described in detail using the embodiments; however, the present disclosure is not limited thereto. For example, a new embodiment may be formed by combining at least parts of a plurality of embodiments described below.

### First Embodiment

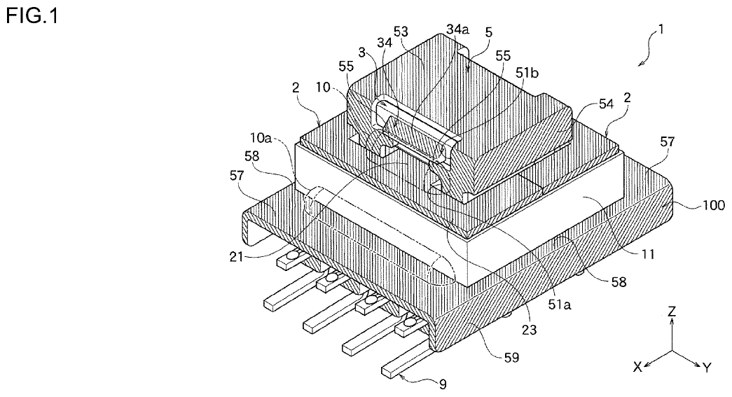

As shown in FIG. 1, a coil component 1 according to the present embodiment may be used for an on-board charger in Electric Vehicles (EV), Plug-in Hybrid Vehicles (PHV), commuter vehicles, or so. It may also be used for a power circuit in house hold or industrial electronic device, or a power circuit of computer devices. Further, it may be used as a transformer to which a high-voltage is applied.

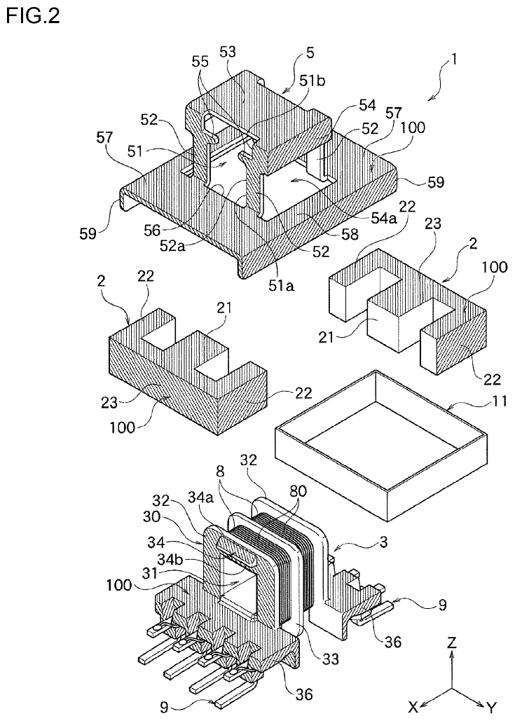

As shown in FIG. 1 and FIG. 2, this coil component 1 includes a core (magnetic core) 2, a bobbin 3, and a cover 5. Note that, in the figures, X-axis, Y-axis, and Z-axis are perpendicular to each other; and, the Z-axis corresponds to a height (thickness) of the coil component 1. Also, the X-axis is parallel to a winding axis of the coil part which is described later.

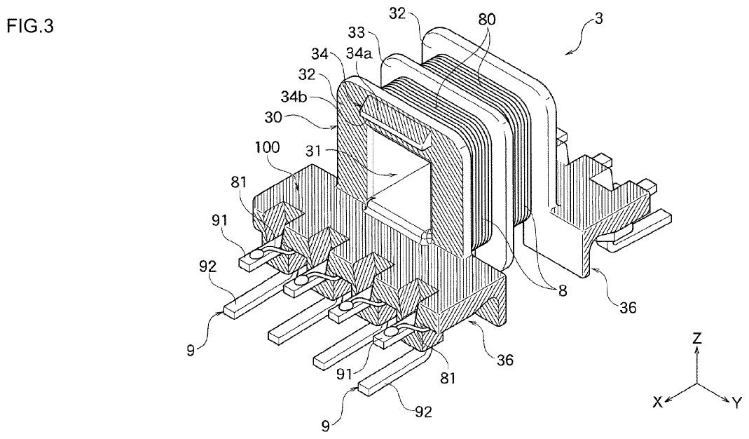

As shown in FIG. 2 and FIG. 3, the bobbin 3 includes a tubular part 30, and a pair of terminal blocks 36 and 36 formed integral with the tubular part 30 so that each of the terminal blocks 36 and 36 are positioned opposite to each other in the X-axis direction of the tubular part 30.

Note that, in the present embodiment, the pair of terminal blocks 36 and 36 has the same configurations; however, the shape of each of these does not necessarily have to be the same. For example, the number of terminals 9 installed on one terminal block 36 and the number of terminals 9 installed on the other terminal block 36 may be different. Also, for example, the shape of terminal 9 installed on one terminal block 36 and the shape of terminal 9 installed on the other terminal block 36 may be different. Also, the shapes of terminal blocks may be different.

The tubular part 30 of the bobbin 3 includes a winding core part where the wire 8 is wound around, and a first end flange 32 and a second end flange 32 which are positioned on both sides in the X-axis direction of the winding core part. Also, at the outer circumference of the winding core part of the tubular part 30 positioned between the first end flange 32 and the second end flange 32, the middle flange 33 is integrally formed. At the tubular part 30, a core leg through hole 31 is formed which penetrates through along the X-axis direction of the winding core part on which the first end flange 32, the middle flange 33, and the second end flange 32 are formed.

In the present embodiment, the cores 2 and 2 have the same shapes which the cross-section shapes along the X-Y plane are E-shape, and each of these cores are a so-called E-shape core. That is, each of cores 2 and 2 respectively has a base part 23 extending in the Y-axis direction, a pair of outer leg parts 22 and 22 protruding out along the X-axis from both ends in the Y-axis direction of the base part 23, and a middle leg part 21 protruding out along the X-axis from a center area in the Y-axis direction between the outer leg parts 22 and 22.

In the present embodiment, the middle leg parts 21 and 21 are made so that these can be inserted from both ends in the X-axis direction into the core leg through hole 31 of the bobbin 3. At the inside of the core leg through hole 31 of the bobbin 3, the tips of the middle leg parts 21 and 21 may face and contact each other, or may face each other while having a predetermined gap in between. Note that, by forming such gap, a leakage characteristic can be adjusted depending on a width of the gap.

As shown in FIG. 2, each of the middle leg parts 21 and 21 has a square prism shape so as to match an inner circumference shape of the core leg through hole 31; however, the shape of the middle leg part is not limited to this, and it may change according to the shape of the core leg through hole 31. Also, each of the outer leg parts 22 and 22 has a shape which matches an end face shape in the Y-axis direction of the flanges 32 and 33; and an outer surface of the outer leg part 22 includes a plane which is parallel to a XZ plane (a plane including the X-axis and the Z-axis). In the present embodiment, the material of the core 2 may be metals, a soft magnetic material such as ferrite; however, it is not limited thereto.

The terminal blocks 36 and 36 respectively extends to outside along the X-axis from the lower side in the Z-axis direction of the end flanges 32 and 32 (it extends to the outside from the center of the bobbin 3. The same applies hereinbelow). Preferably, the upper face along the Z-axis direction of the terminal block 36 is lower than a bottom face of the through hole 31 by a length equivalent to a thickness of the terminal block cover part 57 of the cover 5 which is described later. The upper face of the terminal block cover part 57 and the bottom face of the through hole 31 may be configured to have no difference in height between each other. By having such configuration, the middle leg part 21 of the core 2 can smoothly move to the bottom face of the through hole 31 from the upper face of the terminal block cover part 57.

Also, the widths of the terminal blocks 36 and 36 in the Y-axis direction are wider than the Y-axis direction widths of the end flanges 32 and 32, and the terminal blocks 36 and 36 protrude out by predetermined widths from the both end faces of the flanges 32 in the Y-axis direction. The predetermined widths of protrusion of the terminal blocks 36 and 36 along the Y-axis from the both end faces of the flanges 32 and 32 in the Y-axis direction are preferably about the same as the Y-axis direction widths of the outer leg parts 22 of the core 2. The upper faces of the terminal blocks 36 and 36 are covered with the terminal block cover parts 57 and 57 of the cover 5, and the cores 2 and 2 are arranged thereon.

For each terminal block 36, a plurality of terminals 9 is aligned and embedded along the Y-axis. As shown in FIG. 3, each terminal 9 has a wire connection part 91 and a mounting part 92, and the terminal 9 is insert molded to the terminal block 36 of the bobbin 3 so that the space between the wire connection part 91 and the mounting part 92 is embedded in the terminal block 36.

One lead part 81 among a plurality of wires 8 is connected to the wire connection part 91. The mounting part 92 is a part which connects to a circuit pattern such as a circuit board not shown in the figure, and through each terminal 9, a coil part 80, which is formed by the wires 8, is connected to the outside circuit such as a circuit board.

As shown in FIG. 3, in the present embodiment, the wires 8 are wound around the outer circumference of the winding core part which is positioned between the first flange 32 and the middle flange 33, and also positioned between the middle flange 33 and the second flange 32; thereby, a single transformer or a plurality of transformers is configured by the coil part 80 and the coil part 80.

The wire 8 may be made of a single wire, or may be made of a stranded wire such as a Litz wire. A diameter of the wire 8 is not particularly limited, and preferably it may be 0.1 to 0.4 mm. The wire 8 may be configured of a conductive wire such as a metal wire, or it may be configured of an insulation coated wire.

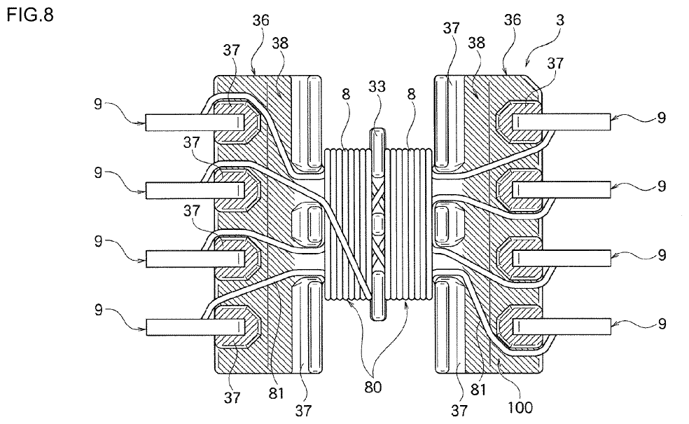

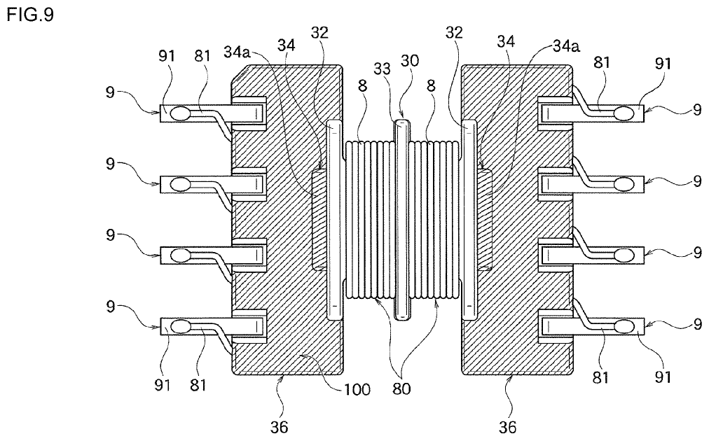

As shown in FIG. 8, a pair of lead parts 81 and 81 which is both ends of one wire 8 configuring the coil part 80 passes through lead passages 38 formed between reinforcement ribs 37 at the bottom face of the terminal block 36 to guide the lead parts 81 towards each terminal 9; and as shown in FIG. 9, the lead parts 81 and 81 are respectively connected to the wire connection parts 91 of the terminals 9.

The bobbin 3 including the tubular part 30 and the terminal blocks 36 are integrally formed, for example, by using plastics such as PPS, PET, PBT, LCP, and nylon; however, it may be made of any other insulation materials. Note that, in the present embodiment, the bobbin 3 is preferably made of plastic with high thermal conductivity of 1 W/m·K or higher; and for example, it may be made of PPS, nylon, and so on.

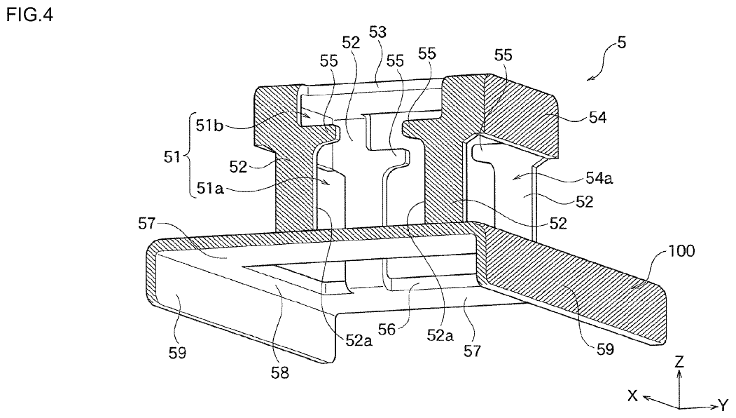

As shown in FIG. 2 and FIG. 4, the cover 5 is made of a member separate from the bobbin 3. This cover 5 can be made of the same insulation material as the bobbin 3, and it may be preferably made of an insulation material having a higher resilience than the bobbin 3. For example, the cover 5 may be preferably made of LCP, nylon, and so on.

The cover 5 includes the terminal block cover parts 57 and 57 respectively covering the upper face along the Z-axis direction of the pair of terminal blocks 36 and 36, and connecting cover parts 58 and 58 extending along the X-axis direction so as to connect the both ends in the Y-axis direction of the terminal block cover parts 57 and 57. The upper faces of the terminal block cover parts 57 and 57 and the connecting cover parts 58 and 58 are one continuous surface, and the base parts 23 and 23 and the outer leg parts 22 and 22 of the cores 2 and 2 are arranged on the terminal cover part 57 and the connecting cover part 58. At both ends in the Y-axis direction of the terminal block cover parts 57 and 57 and the connecting cover parts 58 and 58, side end cover parts 59 are integrally formed which covers the upper parts of the both end faces along the Y-axis of the terminal blocks 36 and 36.

At the center part of the cover 5 which is surrounded by the terminal block cover parts 57 and 57 and the connecting cover parts 58 and 58, a center opening 56 is formed; and the upper part of the tubular part 30 of the bobbin 3 can be inserted into the center opening 56 from the lower side along the Z-axis direction.

At each of opening edges of both ends along the X-axis of the center opening 56 of the cover 5, end walls 52 are formed so that it stands upwards in the Z-axis direction. At the center part in the Y-axis direction of each end wall 52, an end wall opening 51 is formed which intersects and communicates with the center opening 56. The cover 5 includes an upper wall 53 so that the upper end along the Z-axis of each of the end walls 52 positioned at both ends along the X-axis is connected by the upper wall 53.

Also, the cover 5 includes side walls 54 and 54 which are integrally formed so as to connect the upper parts of both ends along the Y-axis direction of the end walls 52 positioned at both sides along the X-axis. A lower side along the Z-axis of each side wall 54 is cutout so that each of the side walls 54 and 54 do not directly contact the connecting cover part 58; and the side walls 54 and 54 of the cover 5 include side openings 54a which connect with the center opening 56.

As shown in FIG. 4, each end wall opening 51 is separated into a main opening 51a and a sub-opening 51b by having claw-like parts 55 which project into the end wall opening 51 from the opening edges 52a positioned at both sides along the Y-axis of the end wall opening 51; and the main opening 51a and the sub-opening 51b are continuous with each other. A width of the main opening 51a along the Y-axis is narrower than a width of the sub-opening 51b along the Y-axis; and a width along the Y-axis direction between the claw-like parts 55 and 55, which are positioned on both sides of the end wall opening 51 along the Y-axis, is narrower than a width of the main opening 51a along the Y-axis.

By making the width along the Y-axis direction of the sub-opening 51b wider than the width along the Y-axis of the main opening 51a, the claw-like parts 55 can easily deform resiliently, and also the adhesive 10 easily enters inside the sub-opening 51b. The upper end of the sub-opening 51b extends in a way that the upper wall 53 is partially cutout from the intersection part of the end wall 52 and the upper wall 53.

As shown in FIG. 2 and FIG. 3, at upper side along the Z-axis of the end face in the X-axis of the end flange 32 of the bobbin 3, a raised part 34 as the second engagement part is integrally formed at the position above the through hole 31. The raised part 34 is formed so that it projects out along the X-axis from the end face in the X-axis of the end flange 32.

A length of the raised part 34 along the Y-axis is shorter than the width along the Y-axis between the claw-like parts 55 and 55 positioned on both sides along the Y-axis of the end wall opening 51, or the length of the raised part 34 may be the same length as the main opening 51a along the Y-axis, or may be slightly longer than this. This allows the raised part 34 to enter inside the main opening 51a, and to contact the slanted face 34a of the raised part 34 with the claw-like parts 55 and 55.

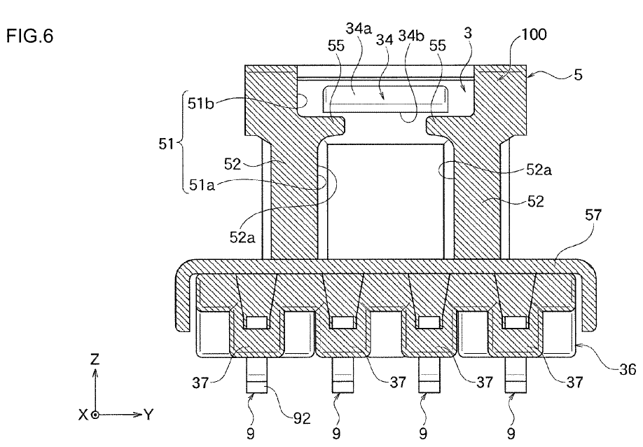

As shown in FIG. 3, the raised part 34 includes a slanted face 34a and a hook part 34b. The slanted face 34a resiliently deforms the claw-like parts 55 as the first engagement part shown in FIG. 2 along the X-axis and guides the claw-like parts 55 along the slanted face towards the hook part 34b, and the hook part 34b is where the claw-like parts 55 are latched. The hook part 34b is formed at a lower side along the Z-axis of the slanted face 34a, and it forms a lower face of the raised part 34. The slanted face 34a forms the upper face of the raised part 34. As shown in FIG. 6, at the position where the hook part 34b of the raised part 34 is formed, the claw-like parts 55 and 55 are formed at the opening edge 52a of the end wall 52 so that the claw-like parts 55 and 55 latch to the hook part 34b from the both sides along the Y-axis.

The width between the end wall 52 and the end wall 52 shown in FIG. 4 which are facing each other along the X-axis is about the same as or slightly wider than the width between the end face of the end flange 32 and the end face of the end flange 32 of the bobbin 3 shown in FIG. 3 which are facing each other along the X-axis. Also, a height of projection of the raised part 34 formed to the end face of the end flange 32 is designed such that the raised part 34 projects out along the X-axis from the sub-opening 51b of the cover 5 once the cover 5 is installed on the bobbin 3 as shown in FIG. 1.

Therefore, when the cover 5 is placed over the bobbin 3 from above along the Z-axis, the claw-like parts 55 contact the slanted face 34a of the raised part 34, and the claw-like parts 55 resiliently deform along the X-axis direction. Then, the claw-like parts 55 are guided to the hook part 34b. Once the claw-like parts 55 and 55 pass through the position where the raised part 34 is most protruded outward, the shapes of the claw-like parts 55 and 55 return to the original shapes, and the claw-like parts 55 and 55 automatically latch to the raised part 34b from both sides along the Y-axis.

In the present embodiment, as shown in FIG. 3, the surface of the terminal block 36 positioned near at least the wire connection part 91 or the mounting part 92 has a detection motif 100. Note that, “near the wire connection part 91 or the mounting part 92”, for example, refers to the surface of a member such as the terminal block 36 that is positioned within a sphere of radius r, centered around the portion of the wire connection part 91 or the mounting part 92 protruding from the surface of the terminal block 36. The radius r is determined depending on the area where a foreign object such as a solder ball can potentially scatter when connecting the lead part 81 of the wire to the wire connection part 91, and although the radius r is not particularly limited, it may be within 10 mm.

Note that, in the present embodiment, other than the surface of the terminal block 32 near the wire connection part 91 or the mounting part 92, almost the entire surface of the terminal block 36 has the detection motif 100 in a continuous manner. For example, the upper surface and the rear surface of the terminal block 36 which are approximately perpendicular to the Z-axis, the side surfaces which are approximately perpendicular to the Y-axis have the detection motif 100 in a continuous manner. Also, the outer surface of the end flange 32 of the bobbin 3 has the detection motif 100. Note that, in the figure, the detection motif 100 is shown in a diagonal hatched pattern.

Also, in the present embodiment, as shown in FIG. 2, the detection motif 100 is also formed on the outer surface of the cover 5 and the outer surface of the core 2. Also, in the present embodiment, an outer surface of the tape 11 may not have the detection motif 100. Note that, in the case that the detection motif 100 is provided to the outer surface of the tape 11, the motif does not have to be a repetitive pattern having ridges and grooves which is described later, and it may be a flat-printed pattern without ridges and grooves.

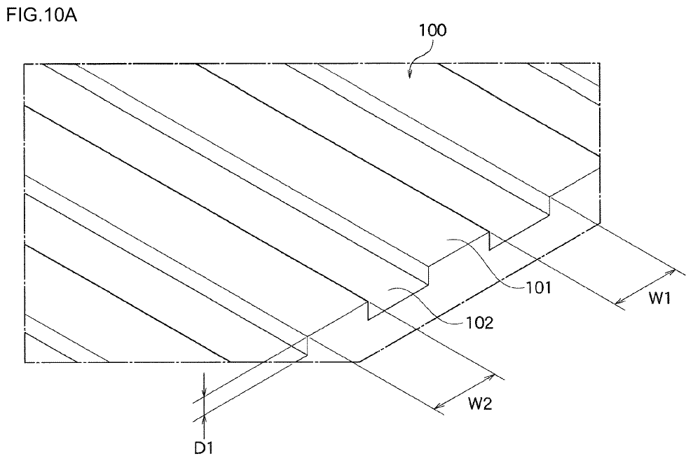

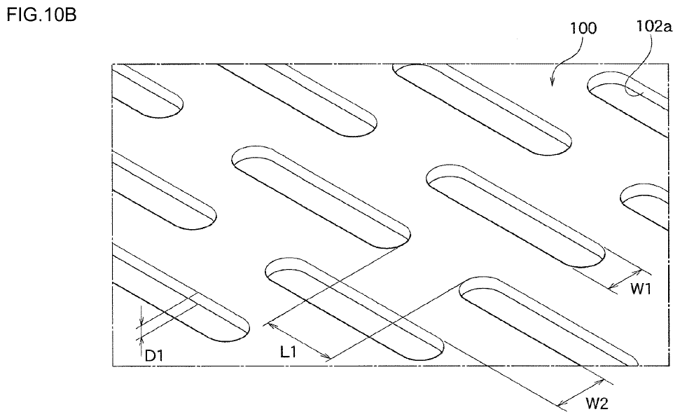

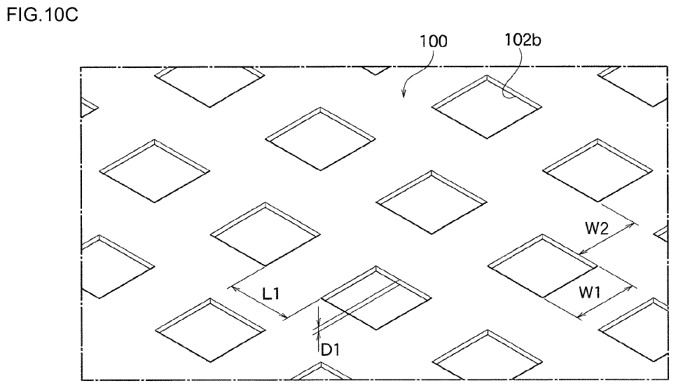

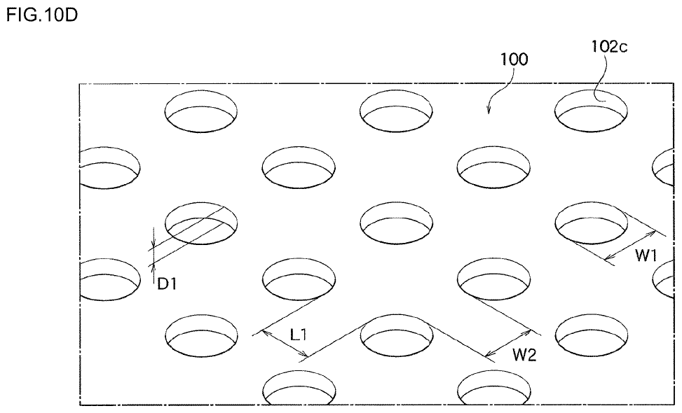

In the present embodiment, for example as shown in FIG. 10A, a surface 101 of the member such as the terminal block 36 may have the detection motif 100 configured of a repetitive pattern having ridges and grooves formed of a stripe-pattern with a predetermined spacing W2 and a groove 102 having a depth D1. A width of the groove 102 (pattern width) W1 is not particularly limited, and for example, it may be 0.1 to 5 mm, 0.1 to 3 mm, 0.1 to 1 mm, or 0.1 to 0.5 mm. The width of the groove 102 (pattern width) W1 is preferably uniform along the longitudinal direction of the groove 102, or it may be different.

Also, the spacing W2 of the groove 102 may be the same as the width W1 of the groove 102, or it may be different. For example, the spacing W2 of the groove 102 may be 0.1 to 5 mm, 0.1 to 3 mm, 0.1 to 1 mm, or 0.1 to 0.5 mm. The depth D1 of the groove is not particularly limited, and it may be 0, or larger than 0. The depth D1 is preferably 1/20 or greater than the width W1 of the groove, and preferably it is 0.1 mm or less at maximum.

As the size of the foreign object to be detected, many of the smaller foreign objects are 0.1 mm or larger, and the foreign objects larger than 5 mm are rare, although this depends on the type of the foreign object. Therefore, the pattern width or the pattern spacing of the detection motif may preferably be within the above-mentioned range. However, the pattern width or the pattern spacing may be out of this range depending on the size of the foreign object to be detected.

The groove 102 may be continuous along the longitudinal direction of the groove 102. Alternatively, as shown in FIG. 10B, the groove may be discontinuous as in the case of a groove 102a which has a space L1 in a perpendicular direction with respect to a space W2 along the width direction. The space L1 may be about the same or different from the space W2. The shape of the end part of the groove 102a in the longitudinal direction may be a half-circle as shown in FIG. 10B; however, the shape may be a straight line, a polygonal shape, an oval shape, or any other shapes.

Also, as shown in FIG. 10C, the groove 102b may be a rectangular-shaped groove, a triangular-shaped groove, or any other polygonal-shaped groove greater than pentagonal shape. Further, as shown in FIG. 10D, the groove 102b may be a circular-shaped groove, an oval-shaped groove, a groove which is a combination of polygonal-shaped groove and a square prism-shaped groove, or a groove of any other shape. Note that, the foreign object is not particularly limited, and other than a solder ball, a core fragment, a terminal burr debris, a terminal plating debris, a solder debris, a wire debris, a resin mold burr, etc. may be mentioned.

Next, an example of a production method of the coil component 1 according to the present embodiment is described. As shown in FIG. 3, the coil component 1 is produced by winding the wires 8 around the winding core part of the bobbin 3, and then by assembling the members shown in FIG. 2.

First, the bobbin 3 shown in FIG. 3, FIG. 8, and FIG. 9 is prepared. For example, the bobbin 3 can be formed by an injection molding. To be able to provide the detection motif 100 on the needed spot of the exterior surface of the bobbin 3, for example, a ridges and grooves motif, which is a reversed version of the ridges and grooves shown in FIG. 10A, is formed on an internal surface of the mold. In regards with the cover 5, it is also formed by an injection molding, and as similar to the bobbin 3, the exterior surface of the cover 5 has the detection motif 100.

Next, the wires 8 are wound around the winding core part of the tubular part 30 of the bobbin 3 to form the coil part 80, and the lead parts 81, which are both ends of the wire 8, are connected to the wire connection parts 91 of the terminals 9. A method for connecting the lead parts 81 to the wire connection parts 91 of the terminals 9 is not particularly limited, and examples include caulking, thermal compression bonding, laser welding, and soldering may be mentioned.

Next, the cover 5 shown in FIG. 4 is installed from above on the bobbin 3 shown in FIG. 3. When installing the cover 5 on the bobbin 3, the cover 5 and the bobbin 3 are assembled so that the upper part of the tubular part 30 of the bobbin 3 shown in FIG. 2 is inserted to the center opening 56 of the cover 5. When the cover 5 and the bobbin 3 are assembled, the raised part 34 of the bobbin 3 passes through the main opening 51a of the end wall opening 51 from the center opening 56, and the claw-like parts 55 contact the slanted face 34a of the raised part 34. Then, the claw-like parts 55 resiliently deforms by warping to the outside along the X-axis along the slanted face 34a, and the claw-like parts 55 engages with the hook part 34b of the raised part 34.

As a result, the position of the main opening 51a of the end opening 51 formed on the cover 5 and the position of the through hole 31 of the bobbin 3 are self-aligned. From the sub-opening 51b, the raised part 34 of the bobbin 3 is exposed out of the cover 5. Note that, the claw-like parts 55 are shaped so that the claw-like parts 55 do not enter the through hole 31 of the bobbin 3.

Next, while the cover 5 is installed on the bobbin 3, the cores 2 and 2 are installed to the cover 5 from the both sides along the X-axis. That is, the middle leg parts 21 and 21 are inserted into the through hole 31 of the bobbin 3 from the main opening 51a of the cover 5, and the cores 2 and 2 are installed into the cover 5 so that the outer leg parts 22 and 22 of the cores 2 and 2 are provided on the upper surface of the connecting cover part 58 of the cover 5.

A gap may be formed between the tips of the middle leg parts 21 and 21 which have been inserted in the through hole 31, or the gap may be 0. Also, the tips between the outer leg parts 22 are preferably in contact with each other.

Next, a tape 11 is placed around the cores 2 and 2 installed to the cover 5; thereby, the cores 2 and 2 may be strongly fixed to the cover 5 and the bobbin 3. Note that, the tape 11 is preferably an insulation tape, and for example, it may be made of a plastic or rubber tape. In order to form the detection motif 100 on the outer surface of the tape 11, for example, the detection motif having ridges and grooves may be made by using a press-processing, or a flat detection motif with no ridges and grooves may be formed by printing.

Next, as shown in FIG. 1, the adhesive 10 is applied so that it covers at least part of the raised part 34 of the bobbin 3 projecting out from the sub opening 51b of the cover 5, at least part of the claw-like parts 55 of the cover 5, and at least a part of the core 2 (preferably, a part of a boundary between the middle leg part 21 and the base part 23).

Preferably, the part where the claw-like parts 55 of the cover 5 and the raised part 34 are closest to each other may be included in a fixing area formed by the adhesive 10. Also, the boundary area between the main opening 51a and the sub-opening 51b may be preferably included in the fixing area by the adhesive 10. The adhesive 10 is not particularly limited; and examples include an epoxy-based adhesive and a silicone-based adhesive.

In the present embodiment, for example, as shown in FIG. 1, a sufficient space is formed between the lower part of the raised part 34 projecting out from the sub-opening 51b and the upper surface of the core 2, and also a sufficient space is formed between the claw-like parts 55 and 55; thus, even if the adhesive 10 is a low-fluidity adhesive, the adhesive 10 can easily enter into these spaces. Also, the adhesive can easily enter into the sub-opening 51b positioned around the raised part 34. Thus, the adhesive strength between the core 2, the bobbin 3, and the cover 5 by the adhesive 10 is enhanced, and the strength against vibration load applied on the coil component 1 can be improved. Also, in the present embodiment, since the strength is improved, the cover 5 can be thinned.

Note that, an adhesive 10a, which may be the same as or different from the adhesive 10, may be used for fixing by adhering on the intersection part of the upper surface of the terminal block cover part 57 and the tape 11. Note that, in the case that the tape 11 is not used, the adhesive 10a is used to adhere and fix the base part 23 of the core 2 and the terminal block cover part 57 of the cover 5.

In the coil component 1 according to the present embodiment, when the cover 5 is installed on the bobbin 3, the claw-like parts 55 which are the first engagement part of the cover 5 engage with the raised part 34 of the bobbin 3. Therefore, for example, even in the case of transporting the bobbin 3 to which the cover 5 is installed while holding the upper face of the upper wall 53 of the cover 5 using a suction nozzle, it is less likely that the cover 5 is released from the bobbin 3; thus, the assembling property improves.

Also, when the cover 5 is installed on the bobbin 3, the position of the end wall opening 51 of the cover 5 and the position of the through hole 31 of the bobbin 3 are automatically arranged, and it becomes easy to install the core 2 in the end wall opening 51 and the through hole 31; hence, also from this perspective, the assembling property improves. Also, the cover 5 is fit and fixed on the bobbin 3 by the claw-like parts 55, and for example, the core 2, the bobbin 3, and also the claw-like parts 55 are adhered using the adhesive 10. Thereby, the adhesive strength between the cover 5, the bobbin 3, and the core 2 are improved, and the strength reliability of the coil component 1 is improved.

Also, the tubular part 30 of the bobbin 3 has the end flanges 32 and 32 at the ends along the X-axis; and the end flanges 32 and 32 respectively has the raised parts 34 as the second engagement parts which engage with the claw-like parts 55 and 55 of the cover 5. By configuring as such, the assembling property is further improved, and the strength reliability of the coil component 1 is further improved.

Also, the raised part 34 includes the slanted face 34a which deforms the claw-like parts 55, and guides the claw-like parts 55 along the slanted face 34a to the hook part 34b where the claw-like parts 55 latch. When the cover 5 is being installed on the bobbin 3, the claw-like parts 55 of the cover 5 resiliently deform and move along the slanted face 34a of the raised part 34. Then, the claw-like parts 55 return to the original shapes; thereby, the claw-like parts 55 automatically latch to the hook part 34b. Hence, the cover 5 fits to the bobbin 3 in a one-touch manner. Therefore, the assembling property further improves, and the strength reliability of the coil component 1 further improves.

Further, in the present embodiment, the claw-like part 55 is arranged on the end wall 52 where the end opening 51 is formed. By configuring as such, the claw-like part 55 deforms resiliently, and the cover 5 can easily fit to the bobbin 3 in a one-touch manner. Therefore, the assembling property further improves, and the strength reliability of the coil component 1 further improves.

Also, in the present embodiment, the claw-like part 55 projects into the end opening 51 from the opening edge 52a of the end wall 52, and the claw-like part 55 is provided on each of the both sides in a width direction of the through hole 31. By configuring as such, the first engagement part made of the pair of claw-like parts 55 easily deforms resiliently, and the cover 5 can easily fit to the bobbin 3 in a one-touch manner.

Note that, for other embodiments, a single claw-like part 55 may be formed at one end opening 51, and the other single claw-like part 55 may be formed at the other end opening 51 which is facing said one end opening 51 along the X-axis direction. In such case, the single claw-like part 55 formed at one end opening 51, and the other single claw-like part 55 formed at the other end opening 51 facing each other along the X-axis direction are preferably arranged at the positions which are diagonal to each other when viewed from the Z-axis direction.

In the present embodiment, the claw-like parts 55 and 55 separate the end opening 51 into the main opening 51a and the sub-opening 51b, and the middle leg part 21 can be inserted into the main opening 51a. By configuring as such, the position of the main opening 51a of the cover 5 and the position of the through hole 31 of the bobbin 3 can be aligned even more securely, and the middle leg part 21 of the core 2 can be easily inserted into the through hole 31 and the main opening 51a.

Further, in the present embodiment, the bobbin 3 includes the terminal block 36 to which the terminal 9 is installed where the lead part 81 pulled out from the coil part 80 of the wire 8 is connected, and the cover 5 includes the terminal block cover part 57 covering the terminal block 36. Due to the terminal cover part 57 of the cover 5, the insulation distance between the terminal 9 and the core 2 becomes longer, and withstand voltage improves.

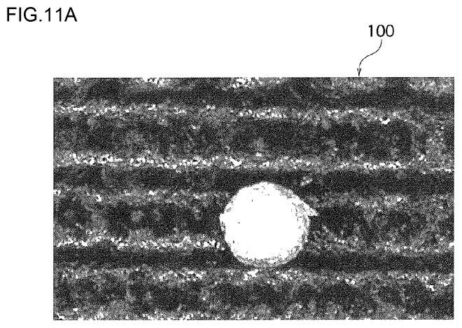

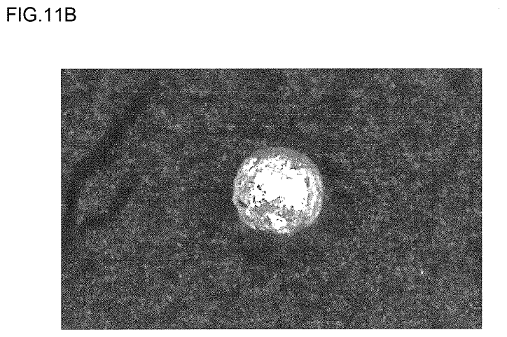

According to the present embodiment, as shown in FIG. 11A, for example, when the foreign object such as a solder ball exists on the detection motif 100, the foreign object is observed while having the detection motif 100 in the background. Hence, the size of the foreign object can be compared to a width of a pattern or a spacing between the patterns; thus, it can be easily determined whether the size of the foreign object is larger or not compared to the width or the spacing. Therefore, according to this coil component 1, a prompt and objective detection of the foreign object having a predetermined size or larger can be done easily by visually checking the outside, by checking the outside using a foreign object detection device (camera), and the like.

Also, depending on the position and the type of the detection motif 100, the detection motif 100 can be used as a mark for setting the position when other members such as the core 2 is installed, and also the detection motif 100 can be used for improved precision of the position of the installing members such as the core 2 and the like.

Further, in the present embodiment, the surface of members such as the core 2 has the detection motif 100 having a repetitive pattern with ridges and grooves; hence, the foreign object on the motif can be observed even more clearly in three-dimension due the difference in reflected light of illumination light; hence, the detection precision of the foreign object further improves.

Also, in the present embodiment, for example as shown in FIG. 1, the adhesives 10 and 10a applied on the predetermined area contacts the surface of the core 2 and the cover 5 which are the members where the detection motif 100 is provided. According to the detection motif 100 having the repetitive pattern with ridges and grooves, the adhesive is held in the groove part and can expect to improve the adhesive strength. Further, depending on the direction of the motif, it is possible to effectively to prevent leakage and spreading of the adhesives 10 and 10a; hence, the adhesive can be easily applied effectively on the predetermined area where it should adhere. Note that, when the adhesive has leaked and spread to the area larger than expected; then, the adhesive may drip and may not have sufficient height. Therefore, the adhesive effect may be lowered.

### Second Embodiment

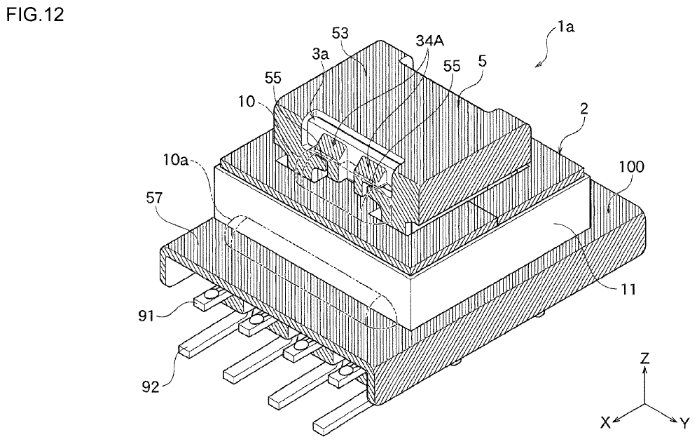

A coil component 1a according to the present embodiment shown in FIG. 12 is different from the coil component 1 of the aforementioned first embodiment in parts shown below; and, the parts which are the same as the first embodiment are omitted form explaining.

In the present embodiment, a bobbin 3a has raised part 34A as the second engagement part which is different from that of the first embodiment. As shown in FIG. 12, in the present embodiment, the raised part 34A formed on at least one of the end flanges 32 of the bobbin 3a is separated along the Y-axis, and when viewed from the X-axis direction, the raised part 34A has an inverted L-shape, and also has a slanted surface and a hook part.

At inside in the Y-axis direction, each raised part 34A is integrally formed with a stopper which extends downward along the Z-axis. Note that, the stopper is separated along the Y-axis when viewed from the X-axis direction; however, it may be a single continuous stopper. That is, the raised part 34A separated along the Y-axis may be continuous.

As each raised part 34A has the stopper, a relative movement of the raised part 34A and the claw-like part 55 in the Y-axis direction is limited, and this prevents the bobbin 3a and the cover 5 from shifting the position in the Y-axis direction.

Note that, as similar to the case of the aforementioned first embodiment, the positions of the cover 5 and the bobbin 3a (also the bobbin 3) along the Z-axis direction are aligned, for example, by contacting the inner face of the terminal block cover part 57 of the cover 5 with the upper face of the terminal block 36 of the bobbin 3 (see FIG. 3). Alternatively, the positions of the cover 5 and the bobbin 3a (also the bobbin 3) along the Z-axis may be aligned, for example, by contacting the inner face of the upper wall 53 of the cover 5 with the upper part of the flanges 32 and 33 of the bobbin 3 (see FIG. 3).

Also, the positions of the cover 5 and the bobbin 3a (also the bobbin 3) along the X-axis are aligned by contacting the inner face of the end wall 52 of the cover 5 to the end face of the end flange 32 of the bobbin 3 (see FIG. 3). Alternatively, the positions of the cover 5 and the bobbin 3a (also the bobbin 3) may be aligned by contacting the inner face of the claw-like part 55 of the cover 5 to the end face of the end flange 32 of the bobbin 3 (see FIG. 3). As similar to the case of the aforementioned first embodiment, the claw-like part 55 may be slightly bent to the inside than the end wall 52 along the X-axis. This allows the claw-like part 55 to easily contact the end face of the end flange 32 of the bobbin 3 (see FIG. 3).

In the present embodiment, the detection motif 100 is provided to the surfaces of the bobbin 3a including the terminal block 36, the core 2, and the cover 5 which are positioned near at least the wire connection part 91 or the mounting part 92. The effects similar to the aforementioned embodiment are exhibited.

### Third Embodiment

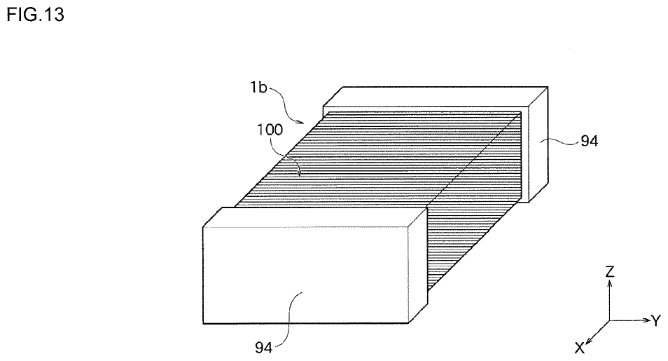

A chip component 1b as an electronic component according to the present embodiment shown in FIG. 13 has different internal configurations compared to the aforementioned third and second embodiments, but the third embodiment and the first and second embodiments are similar in terms of having the detection motif 100 on the surface of the insulation member. Below describes the parts of the third embodiment which are different from the first and second embodiments, and the common parts are not explained as these are redundant.

Examples of the chip component 1b include a capacitor chip, an inductor chip, a varistor chip, and other electronic components; and, the chip component 1b has the detection motif 100 on the insulation surface of the chip main body to which a pair of terminal electrodes 94 and 94 are formed at the both ends along the X-axis. The detection motif 100 can be formed, for example, by a laser processing, a press processing, a printing method, and the like; and the detection motif 100 can be formed before or after forming the terminal electrodes 94.

In the present embodiment, as similar to the aforementioned embodiments, when the foreign object exists on the detection motif 100, the foreign object is observed while having the detection motif 100 in the background. Hence, the size of the foreign object can be compared to a width of a pattern or a spacing between the patterns, thus it can be easily determined whether the size of the foreign object is larger or not compared to the width or the spacing. Therefore, according to this coil component 1b, a prompt and objective detection of the foreign object having a predetermined size or larger can be done easily by checking the outside visually, by checking the outside using a foreign object detection device (camera), and the like.

Also, in the present embodiment, by forming the detection motif 100 using a repetitive pattern with ridges and grooves along the X-axis, it can be expected to be effective for determining the position of the electrodes since the leakage and spreading of the paste can be suppressed when the terminal electrodes 94 and 94 are formed by dipping into the electrode paste.

Note that, the present disclosure is not limited to the above-mentioned embodiments, and various modifications are possible within the scope of the present disclosure. For example, in the embodiment shown in FIG. 13, the detection motif 100 is formed on the entire surface of the chip main body positioned between the terminal electrodes 94 and 94; however, the detection motif may be formed only on the surface of the chip main body positioned near the terminal electrodes 94 and 94.

REFERENCE SIGNS LIST

1, 1a . . . Coil component
1b . . . Chip component
2 . . . Core
21 . . . Middle leg part
22 . . . Outer leg part
23 . . . Base part
3, 3a . . . Bobbin
30 . . . Tubular part
31 . . . Through hole
32 . . . End flange
33 . . . Middle flange
34, 34A . . . Raised part (Second engagement part)
34a . . . Slanted face
34b . . . Hook part
36 . . . Terminal block
37 . . . Reinforcement ribs
38 . . . Lead passage
5 . . . Cover
51 . . . End wall opening
51a . . . Main opening
51b . . . Sub-opening
52 . . . End wall
52a . . . Opening edge
53 . . . Upper wall
54 . . . Side wall
54a . . . Side opening
55 . . . Claw-like part (First engagement part)
56 . . . Center opening
57 . . . Terminal block cover part
58 . . . Connecting cover part
59 . . . Side end cover part
8 . . . Wire
80 . . . Coil part
81 . . . Lead part
9 . . . Terminal
91 . . . Wire connection part
92 . . . Mounting part
94 . . . Terminal electrode
10, 10a . . . Adhesive
11 . . . Tape
100 . . . Detection motif
102, 102a, 102b, 102c . . . Groove

What is claimed is:

1. An electronic component comprising:
a member at least installed with a terminal or an electrode,
wherein a surface of the member has a detection motif having a pattern with a width or a spacing smaller than a size of a foreign object to be detected.

2. The electronic component according to claim 1, wherein the width or the spacing of the detection motif is 0.1 to 5 mm.

3. The electronic component according to claim 1, wherein the detection motif comprises a repetitive pattern with ridges and grooves formed on the surface of the member.

4. The electronic component according to claim 3, wherein an adhesive applied on a predetermined area contacts the surface of the member having the detection motif.

5. A coil component comprising:
a terminal block for installing a terminal,
wherein a surface of the terminal block has a detection motif having a pattern with a width or a spacing smaller than a size of a foreign object to be detected.

6. The coil component according to claim 5, wherein the terminal comprises a wire connection part and a mounting part, and the surface of the terminal block positioned near the wire connection part or the mounting part has the detection motif.

7. The coil component according to claim 5 further comprising a cover including a terminal block cover part at least partially covering the terminal block, and the detection motif is at least provided on a surface of the cover near the terminal.
